(19) United States
(12) Patent Application Publication
(10) Pub. No.: US 2025/0069805 A1
(43) Pub. Date: Feb. 27, 2025

(54) CAPACITOR AND METHOD FOR PRODUCING THE SAME

(71) Applicant: Murata Manufacturing Co., Ltd., Nagaokakyo-shi (JP)

(72) Inventors: Naoki IWAJI, Nagaokakyo-shi (JP); Yuuto YAMAMOTO, Nagaokakyo-shi (JP); Isao KIMURA, Nagaokakyo-shi (JP); Akio MASUNARI, Nagaokakyo-shi (JP)

(21) Appl. No.: 18/942,859

(22) Filed: Nov. 11, 2024

Related U.S. Application Data
(63) Continuation of application No. PCT/JP2024/003498, filed on Feb. 2, 2024.

(30) Foreign Application Priority Data
Jun. 16, 2023 (JP) 2023-099453

(51) Int. Cl. H01G 2/14; H01G 4/002

(52) U.S. Cl. CPC H01G 2/14; H01G 4/002

(57) ABSTRACT

A capacitor that includes: a metal base material; a dielectric layer on the metal base material; a conductive layer on the dielectric layer; an oxide layer between the metal base material and the dielectric layer; and an oxygen barrier layer between the oxide layer and the dielectric layer, wherein the oxide layer includes: a first oxidized region containing a metal of the metal base material; and a second oxidized region containing an atom of the oxygen barrier layer and a metal of the metal base material, and a thickness of the first oxidized region is 3 nm or less and is 0% to 50% of a thickness of the second oxidized region.

### CROSS REFERENCE TO RELATED APPLICATIONS

The present application is a continuation of International application No. PCT/JP2024/003498, filed Feb. 2, 2024, which claims priority to Japanese Patent Application No. 2023-099453, filed Jun. 16, 2023, the entire contents of each of which are incorporated herein by reference.

### TECHNICAL FIELD

The present disclosure relates to a capacitor and a method for producing the same.

### BACKGROUND ART

Conventionally, capacitors have been used in various electronic devices. The capacitor can be obtained by forming a dielectric film exhibiting electrostatic capacitance on a base material and forming a conductor film as an upper electrode on the dielectric film (Patent Document 1).
Patent Document 1: Japanese Patent Application No. 2017-253367

### SUMMARY OF THE DISCLOSURE

The dielectric film or the like may be formed on the base material under an oxidizing atmosphere. Therefore, between the base material and the dielectric film, an oxide film can be formed, the oxide film containing components derived from the base material and/or the dielectric film. When the conductor film is formed on the dielectric film under a reducing atmosphere, the oxide film is reduced, and the volume of the oxide film can change. The volume change may result in defects formed in the dielectric film on the oxide film and a decrease in the withstand voltage characteristics of the dielectric film.

An object of the present disclosure is to provide a capacitor that copes with a decrease in withstand voltage characteristics, and a production method thereof.

The present disclosure provides: a capacitor including: a metal base material; a dielectric layer on the metal base material; a conductive layer on the dielectric layer; an oxide layer between the metal base material and the dielectric layer; and an oxygen barrier layer between the oxide layer and the dielectric layer, wherein the oxide layer includes: a first oxidized region containing a metal of the metal base material; and a second oxidized region containing an atom of the oxygen barrier layer and a metal of the metal base material, and a thickness of the first oxidized region is 3 nm or less and is 0% to 50% of a thickness of the second oxidized region.

The present disclosure provides: a method for producing a capacitor, the method including: forming an oxygen barrier layer on a metal base material; subjecting the metal base material on which the oxygen barrier layer is formed to a reducing treatment; forming a dielectric layer on the oxygen barrier layer; and forming a conductive layer on the dielectric layer.

The present disclosure provides: a capacitor component including: a first electrode; a dielectric layer on the first electrode; an oxide layer between the first electrode and the dielectric layer; and an oxygen barrier layer between the oxide layer and the dielectric layer, wherein the oxide layer includes: a first oxidized region containing a metal of the first electrode; and a second oxidized region containing an atom of the oxygen barrier layer and a metal of the first electrode, and a thickness of the first oxidized region is 3 nm or less and is 0% to 50% of a thickness of the second oxidized region.

The capacitor and the capacitor component of the present disclosure cope with a decrease in withstand voltage characteristics. More specifically, the capacitor and the capacitor component of the present disclosure suppress a decrease in withstand voltage characteristics due to the volume change of the oxide film formed between the base material and the dielectric layer.

The method for producing a capacitor of the present disclosure can provide a capacitor that copes with a decrease in withstand voltage characteristics. More specifically, the method for producing a capacitor of the present disclosure can provide a capacitor that suppresses a decrease in withstand voltage characteristics due to the volume change of the oxide film formed between the base material and the dielectric layer.

### BRIEF EXPLANATION OF THE DRAWINGS

FIG. 1 is a schematic sectional view of a capacitor according to an embodiment of the present disclosure.

FIG. 2 is a partly enlarged schematic sectional view of the oxide layer of the capacitor in FIG. 1.

FIG. 3 is a schematic sectional view of a conventional capacitor.

FIGS. 4(a) through 4(e) are views illustrating a method for producing a capacitor of the present disclosure.

FIG. 5 is a schematic sectional view of a capacitor prepared as Example.

FIG. 6 is a schematic sectional view of a capacitor prepared as Comparative Example.

### DESCRIPTION OF THE PREFERRED EMBODIMENTS

Hereinafter, the capacitor of the present disclosure will be described in more detail. Although the description will be made with reference to the drawings as necessary, various elements in the drawings are only schematically and exemplarily illustrated for the understanding of the capacitor of the present disclosure, and appearances and/or dimensional ratios may be different from actual ones.

Various numerical ranges mentioned herein are intended to include the numerical values themselves of the lower and upper limits. More specifically, when a numerical range such as 1 to 10 is taken as an example, the example can be interpreted as including the lower limit of “1” and also including the upper limit of “10”.

### <Capacitor>

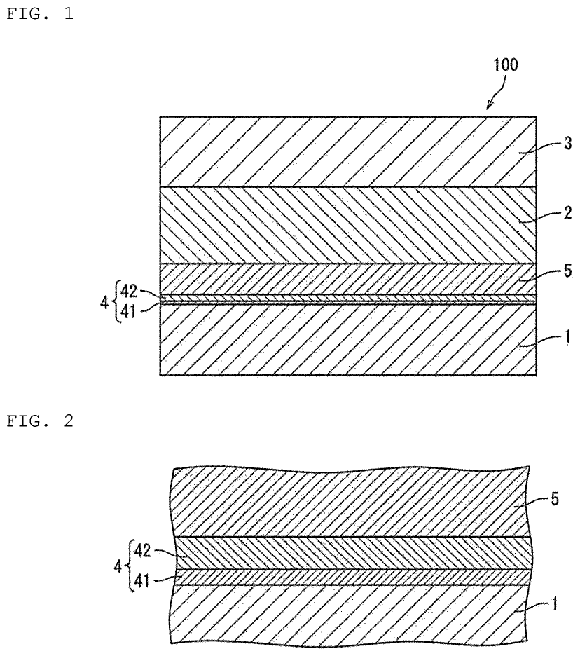

The capacitor of the present disclosure will be described with reference to FIGS. 1 and 2 as an example. A capacitor 100 of the present disclosure includes a metal base material 1, a dielectric layer 2 formed on the metal base material 1, a conductive layer 3 formed on the dielectric layer 2, an oxide layer 4 formed between the metal base material 1 and the dielectric layer 2, and an oxygen barrier layer 5 formed between the oxide layer 4 and the dielectric layer 2. The oxide layer 4 includes: a first oxidized region 41 containing a metal of the metal base material 1; and a second oxidized region 42 containing an atom of a material of the oxygen barrier layer 5 and a metal of the metal base material 1. The thickness of the first oxidized region 41 is 3 nm or less and is 0% to 50% of the thickness of the second oxidized region 42.

In the embodiment illustrated in FIG. 1, the capacitor 100 has a structure in which the metal base material 1, the first oxidized region 41, the second oxidized region 42, the oxygen barrier layer 5, the dielectric layer 2, and the conductive layer 3 are laminated in this order.

The dielectric layer 2 is formed between the metal base material 1 and the conductive layer 3. When a voltage is applied between the metal base material 1 and the conductive layer 3, the dielectric layer 2 can accumulate an electric charge.

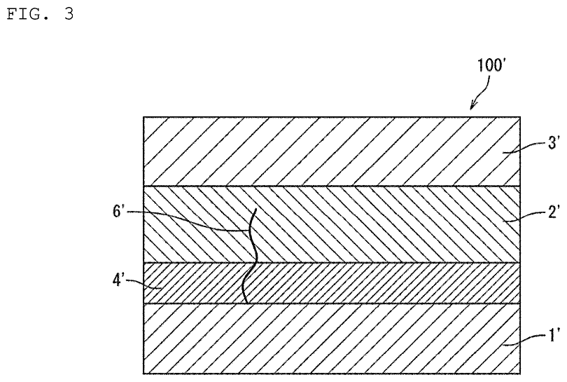

A conventional capacitor is illustrated in FIG. 3. Conventionally, when the oxide layer 4′ formed on the metal base material 1′ of the capacitor 100′ is reduced to change its volume, the volume change may result in defects such as a crack 6′ formed in the dielectric layer 2′ and/or the conductive layer 3′ on the oxide layer 4′ and a decrease in the withstand voltage characteristics of the dielectric layer 2′.

In the capacitor 100 of the present disclosure, the oxygen barrier layer 5 is formed between the oxide layer 4 and the dielectric layer 2, the first oxidized region 41 constituting the oxide layer 4 has a thickness of 3 nm or less, and the thickness of the first oxidized region 41 is 0% to 50% of the thickness of the second oxidized region 42, so that the capacitor 100 copes with a decrease in withstand voltage characteristics. Specifically, when the oxygen barrier layer 5 is formed between the oxide layer 4 and the dielectric layer 2 and the oxide layer 4 has the above thickness, the volume change of the oxide layer 4 is small under a reducing atmosphere, and defects formed in the dielectric layer 2 can be suppressed.

Hereinafter, each member constituting the capacitor of the present disclosure will be described.

### [Metal Base Material]

In the capacitor of the present disclosure, the metal base material is not particularly limited as long as it is a metal having conductivity. For example, the metal base material may comprise at least one metal selected from the group consisting of Al, Ti, Ta, Nb, Ni, Cu, W, Mo, Ir, Ag, Rh, Co, and Fe. The metal base material may be an alloy containing a plurality of the metals.

In an embodiment, the metal of the metal base material may include a non-precious metal. The term “non-precious metal” means a metal other than a noble metal and an alloy thereof. The noble metal means Au, Ag, Pt, Pd, Rh, Ir, Ru, and Os. The metal base material containing a non-precious metal can contribute to cost reduction of the capacitor.

In an embodiment, the metal of the metal base material may include at least one element selected from a group consisting of Cu, Al, Ta, Ti, Ni, Nb, W, Cr, and Fe. The metal base material containing the above elements easily forms a porous metal base material having the following porous structure. Since the porous metal base material easily increases the surface area of the metal base material, the capacitance of the capacitor is easily improved.

In one embodiment, the metal of the metal base material may include at least one element selected from the group consisting of Cu, Ni, and Fe. Since the metal base material containing the elements is easily reduced in the reducing treatment step described in detail below, the capacitor having the metal base material containing the elements easily exhibits the effect of the present disclosure.

The thickness of the metal base material is not particularly limited, and can be appropriately selected according to the purpose. For example, the thickness of the metal base material may be 10 μm to 1000 μm, and preferably 30 μm to 300 μm. The thickness of the metal base material means a length in the direction perpendicular to the mounting surface of the capacitor.

The metal base material may be formed on a substrate, such as a semiconductor substrate such as a silicon (Si) substrate or a gallium arsenide (GaAs) substrate, or an insulating substrate such as glass or alumina.

From the viewpoint of improving adhesion between the metal base material and the substrate, an adhesion layer may be formed between the metal base material and the substrate. As the material of the adhesion layer, Ti, Cr, or the like may be used. The thickness of the adhesion layer may be, for example, 0.1 nm to 50 nm, preferably 1 nm to 20 nm, and more preferably 2 nm to 10 nm.

### (Porous Metal Base Material)

In an embodiment, the metal base material may be a porous metal base material. Since the porous metal base material has a porous structure and tends to have a large surface area, the capacitance of the capacitor using the porous metal base material can be further improved.

The porous metal base material can be prepared by a method well known in the art, such as etching, sintering, or a dealloying method. As the porous metal base material, a commercially available porous metal base material may be used.

In an embodiment, the porous metal base material may have a high porosity portion and a low porosity portion. The term “high porosity portion” means a portion having a higher porosity and a larger specific surface area than the low porosity portion in the porous metal base material, which constitutes a capacitance-forming portion in the capacitor of the present disclosure. The term “low porosity portion” means a portion having a lower porosity and a smaller specific surface area than the high porosity portion in the porous metal base material, which can contribute to enhancing the mechanical strength of the capacitor of the present disclosure.

In the present disclosure, the term “porosity” means the proportion of voids in the porous metal base material. The porosity can be measured in the following manner. The voids in the porous metal base material can be finally filled with the dielectric layer, the conductive layer, and the like in the process of making the capacitor. However, the “porosity” is calculated under the condition that the thus filled substances are not considered and the filled parts are also regarded as voids.

First, the conductive porous base material is processed into a thin piece sample having a thickness of 60 nm or less by a focused ion beam (FIB) micro sampling method. A predetermined region (3 μm×3 μm) of the thin piece sample is measured by scanning transmission electron microscope (STEM)-energy dispersive X-ray spectrometry (EDS) mapping analysis. In the visual field of the mapping measurement, the area where a material constituting the conductive porous base material is present is determined. Then, the porosity can be calculated from the following equation. This measurement is performed at any three positions, and the average value of the measurement values is determined as the porosity.

Porosity (%)=((measurement area−area where material constituting base material is present)/measurement area)×100

From the viewpoint of increasing the specific surface area and further increasing the capacitance of the capacitor, the porosity of the high porosity portion may be preferably 20% or more, more preferably 30% or more, and still more preferably 35% or more. Meanwhile, the porosity is preferably 90% or less, more preferably 80% or less from the viewpoint of ensuring the mechanical strength.

From the viewpoint of enhancing the mechanical strength, the porosity of the low porosity portion is preferably 60% or less of the porosity of the high porosity portion, and more preferably 50% or less of the porosity of the high porosity portion. For example, the porosity of the low porosity portion is preferably 20% or less, and more preferably 10% or less. The low porosity portion may have a porosity of 0%.

The width of the low porosity portion (the length in the direction of the mounting surface of the capacitor) is 3 μm to 1 mm, and preferably 10 μm to 500 μm. When the low porosity portion has a width of 3 μm or more, preferably 10 μm or more, the capacitor has an enhanced mechanical strength. When the low porosity portion has a width of 1 mm or less, a larger high porosity portion can be secured in the porous metal base material with a constant volume, and a high capacitance can be obtained. The thickness of the low porosity portion (the length in the direction perpendicular to the mounting surface of the capacitor) is preferably 50% or more of the thickness of the porous metal base material, and preferably equal to the thickness of the porous metal base material (that is, the total thickness of the porous metal base material) in order to enhance the mechanical strength of the capacitor.

The method for forming the low porosity portion is not particularly limited as long as a desired porosity can be obtained, but it is preferable to form the low porosity portion by, for example, pressing with a mold or the like. The porous metal base material may be pressed such that the porous metal base material is sandwiched from the upper and lower surfaces, or may be pressed from only one surface.

Alternatively, the low porosity portion may be formed by irradiating a porous metal base material previously made porous with a CO₂ laser, a YAG laser, an excimer laser, and an all-solid-state pulsed laser such as a femtosecond laser, a picosecond laser, and a nanosecond laser to crush the pores. Since the low porosity portion can be more precisely controlled in its shape and porosity, an all-solid-state pulsed laser such as a femtosecond laser, a picosecond laser, and a nanosecond laser is preferable.

The low porosity portion may be formed by filling the pores in the high porosity portion as described above. Also, the low porosity portion may be formed in a process where a non-porous metal base material is formed with pores. For example, when a porous metal foil is produced by etching, the portion where the low porosity portion is to be formed is masked and then etching is performed, so that the masked portion becomes the non-etched layer. Thereby, the low-porosity portion is formed. When the low porosity portion is formed in the central part of the foil, the etching is stopped before the pores are formed in the central part of the foil, so that the central part becomes the non-etched layer. Thereby, the low porosity portion is formed.

By combining the pressing, the laser processing, and the formation of the non-etched layer, the low porosity portion can be formed in various shapes.

### [Dielectric Layer]

In the capacitor of the present disclosure, the dielectric layer 2 is formed on the metal base material 1. The term “on the metal base material” does not require being in contact with the metal base material, and means the space above the main surface of the metal base material.

In an embodiment, the dielectric layer is not particularly limited as long as it has an insulating property. However, the dielectric layer may contain at least one element selected from the group consisting of Al, Si, Ti, Hf, Ta, Zr, W, Sr, Pb, and Ba.

As the material that forms the dielectric layer, examples thereof include: metal oxides such as AlOₓ (for example, Al₂O₃), SiOₓ (for example, SiO₂), AlTiOₓ, SiTiOₓ, HfOₓ, TaOₓ, ZrOₓ, HfSiOₓ, ZrSiOₓ, TiZrOₓ, TiZrWOₓ, TiOₓ, SrTiOₓ, PbTiOₓ, BaTiOₓ, BaSrTiOₓ, BaCaTiOₓ, and SiAlOₓ; metal nitrides such as AlNₓ, SiNₓ, and AlScNₓ; and metal oxynitrides such as AlOₓN_{y}, SiOₓN_{y}, HfSiOₓN_{y}, and SiCₓO_{y}N_{z}, where AlOₓ, SiOₓ, SiOₓN_{y}, and HfSiOₓ are preferable. The formulae are merely intended to represent the constitution of the materials and are not intended to limit the composition. That is, x, y and z assigned to O and N may be any value larger than 0, and each element including metal element has any abundance ratio. Alternatively, the dielectric layer may be a layered compound composed of a plurality of different layers.

The thickness of the dielectric layer is not particularly limited, and is preferably 3 nm to 100 nm, and more preferably 5 nm to 50 nm, for example. When the thickness of the dielectric layer is 3 nm or more, insulating properties can be enhanced to reduce leakage current. When the thickness of the dielectric layer is 100 nm or less, higher capacitance can be obtained.

The dielectric layer is preferably formed by a gas phase method such as a vacuum deposition method, a chemical vapor deposition (CVD) method, a sputtering method, an atomic layer deposition (ALD) method, a pulsed laser deposition (PLD) method, or the like, or a method using a supercritical fluid. The ALD method is more preferable from the viewpoint that a uniform and dense film can be formed. For example, in the ALD method, a more homogeneous and dense film can be formed also in the detail of the pores in the high porosity portion.

### [Conductive Layer]

In the capacitor of the present disclosure, the conductive layer 3 is formed on the dielectric layer 2. The conductive layer 3 has conductivity. The dielectric layer 2 is present between the conductive layer 3 and the metal base material 1. Electric charges can be accumulated in the dielectric layer 2 by applying a voltage between the metal base material 1 and the conductive layer 3. When the metal base material 1 is a mounting portion, the metal base material 1 corresponds to the bottom portion of the capacitor. Accordingly, the conductive layer 3 can be regarded as the upper electrode.

The conductive layer is not particularly limited as long as it is conductive. The conductive layer may contain at least one selected from the group consisting of Ni, Cu, W, Ti, Ag, Au, Pt, Zn, Sn, Pb, Fe, Cr, Mo, Ru, and Pd. The conductive layer may be an alloy layer, a nitride layer, or an oxynitride layer. The alloy layer may be, for example, CuNi, AuNi, or AuSn. The nitride layer and the oxynitride layer may be a metal nitride layer and a metal oxynitride, and may be specifically TiN, TiAIN, TION, TiALON, TAN, or the like.

In an embodiment, the conductive layer may contain at least one element selected from the group consisting of Ti, W, Ni, Cu, Ag, Ru, and Pt. Containing the above elements, the conductive layer can be more excellent in conductivity.

In an embodiment, the conductive layer may be a conductive layer made of a nitride film. The nitride film is preferably TiN or TiON. When the conductive layer is a conductive layer made of a nitride film, the conductive layer can be more excellent in conductivity.

The thickness of the conductive layer is not particularly limited, but is, for example, preferably 3 nm or more, and more preferably 10 nm or more. When the thickness of the conductive layer is 3 nm or more, the resistance of the conductive layer itself can be small.

The conductive layer can be formed by an ALD method. By using the ALD method, it is possible to further increase the capacitance of the capacitor. Alternatively, the conductive layer may be formed by a method such as a chemical vapor deposition (CVD) method, plating, bias sputtering, a sol-gel method, or conductive polymer filling, which can cover the dielectric layer and substantially fill the pores in the porous metal base material. Preferably, the conductive layer may be formed by: forming a conductive layer on the dielectric layer through an ALD method; and from the above, laminating a conductive substance, preferably a substance having a smaller electric resistance, through another method. This configuration can efficiently provide a higher capacitance density and a lower ESR.

When the conductive layer does not have sufficient conductivity as a capacitor electrode after the conductive layer is formed, an extended electrode layer made of Al, Cu, Ni or the like may be additionally formed on the surface of the conductive layer by a method such as spattering, deposition, or plating.

The thickness of the conductive layer is not particularly limited, but is, for example, preferably 3 nm or more, and more preferably 10 nm or more. When the thickness of the conductive layer is 3 nm or more, the resistance of the conductive layer itself can be small.

### [Oxide Layer]

The oxide layer 4 is formed between the metal base material 1 and the dielectric layer 2. The oxide layer 4 is only located between the metal base material 1 and the dielectric layer 2, and does not required to be in direct contact with either of them. The oxide layer contains an oxide. The oxide layer may contain only an oxide, or may contain a compound containing oxygen, such as an oxynitride and a hydroxide.

The oxide layer may be an oxide layer of metal contained in the capacitor, and may be, for example, an oxide layer of metal contained in the metal base material.

In an embodiment, the thickness of the oxide layer may be 10 nm or less. From the viewpoint of further suppressing a decrease in withstand voltage characteristics, the thickness of the oxide layer may be 8 nm or less, preferably 6 nm or less, more preferably 4 nm or less, and still more preferably 2 nm or less. When the oxide layer is made of a plurality of layers, the thickness of the oxide layer means the total thickness value of these layers. For example, when the oxide layer includes the first oxidized region and the second oxidized region described later, the thickness of the oxide layer is the total value of the thickness of the first oxidized region and the thickness of the second oxidized region.

In an embodiment, the thickness of the oxide layer may be 10% or less of the thickness of the dielectric layer. When the thickness of the oxide layer is within the above range, defects formed in the dielectric layer due to the volume change of the oxide layer can be further suppressed. From the viewpoint of further suppressing a decrease in withstand voltage characteristics, the thickness of the oxide layer may be 8% or less, preferably 6% or less, and more preferably 4% or less of the thickness of the dielectric layer.

In the capacitor of the present disclosure, the oxide layer 4 includes a first oxidized region 41 and a second oxidized region 42.

### [First Oxidized Region]

The first oxidized region 41 contains a metal of the metal base material 1. Specifically, the first oxidized region contains an oxide of a metal of the metal base material. The first oxidized region does not contain a metal of the oxygen barrier layer. The first oxidized region 41 is formed closer to the metal base material 1 than the second oxidized region 42. The first oxidized region 41 is located between the metal base material 1 and the second oxidized region 42.

The first oxidized region is formed when the metal base material is oxidized. For example, the first oxidized region can be formed when the surface of the metal base material is naturally oxidized in the production of the capacitor, and/or when another layer is formed, for example, the oxygen barrier layer is formed.

The first oxidized region can change in volume upon reduction. When the volume of the first oxidized region changes, the dielectric layer formed on the first oxidized region is applied with stress due to the volume change. For example, when the first oxidized region contracts due to reduction, the dielectric layer can be applied with stress generated by the contraction. When the volume of the first is greatly changed, the generated stress easily increases, and therefore defects are easily formed in the dielectric layer. Therefore, the volume change of the first oxidized region is preferably small.

In an embodiment, the thickness of the first oxidized region is preferably 3 nm or less from the viewpoint of suppressing defects formed in the dielectric layer. When the thickness of the first oxidized region is 3 nm, the dielectric layer is difficult to form defects due to the volume change of the first oxidized region. From the viewpoint of further suppressing defects formed in the dielectric layer, the thickness of the first oxidized region may be 2.5 nm or less, preferably 2 nm or less, more preferably 1.5 nm or less, still more preferably 1.0 nm or less, and particularly preferably 0.5 nm or less. In an embodiment, the thickness of the first oxidized region may be 0 nm, that is, less than or equal to the detection limit, or the first oxidized region may be absent.

In an embodiment, the thickness of the first oxidized region may be 0% to 50% of the thickness of the second oxidized region. When the thickness of the first oxidized region is within the above range, the dielectric layer is difficult to form defects due to the volume change of the first oxidized region. From the viewpoint of suppressing defects formed in the dielectric layer, the thickness of the first oxidized region may be 18 to 45%, preferably 2% to 40%, more preferably 2% to 35%, still more preferably 3% to 30%, and particularly preferably 5% to 25% of the thickness of the second oxidized region. The phrase “the thickness of the first oxidized region is 0% of the thickness of the second oxidized region” means that the first oxidized region is substantially absent.

The thickness of the first oxidized region can be measured by RBS analysis or STEM-EDX analysis.

### (Rbs Analysis)

When the thickness of the first oxidized region in the present disclosure is measured by RBS analysis, the RBS analysis can be performed using a high-resolution RBS surface analyzer HRBS500 (manufactured by Kobe Steel, Ltd.). In the RBS analysis, the first oxidized region and other components (for example, the dielectric layer) can be separately measured by automatic measurement with the analyzer or by analyzing the measurement region. Measurement conditions when using the analyzer are as follows.

### <Measurement Conditions>

Incident ion: 450 keV Het
Detection ion: Scattering Het
Scattering angle: 70°
Incident angle*: 55°
Sample current: 10 nA
Irradiation dose: 12.5 μC
In-plane rotation: No
Detector**: MCP/PSD
*Angle of sample surface from normal line
**MCP=Micro Channel Plate, PSD=Position Sensitive Detector, SSD=Solid State Detector

### (STEM-EDX Analysis)

When the thickness of the first oxidized region in the present disclosure is measured by STEM-EDX analysis, the STEM-EDX analysis can be performed using JEM-ARM200F (manufactured by JEOL Ltd.) as an electron microscope (STEM) and JED-2300T (manufactured by JEOL Ltd.) as an EDX. In the STEM-EDX analysis, the first oxidized region and other components (for example, the dielectric layer) can be separately measured by automatic measurement with the analyzer or by analyzing the measurement region.

Measurement conditions when using the analyzer are as follows.

### <Measurement Conditions>

Acceleration voltage: 200 kV

### (The Acceleration Voltage May be Changed to 100 kV

### Or 300 kV According to the State of the Sample)

Electronic probe size (spatial resolution): 0.2 nm or less

### <Measurement Procedure>

Prepared is an evaluation sample processed into a thin piece having a thickness of 30 nm or less. By aberration-corrected STEM-EDX analysis under the above measurement conditions, the section of the evaluation sample is subjected to EDX analysis in a region having a position resolution of 0.2 nm or less, and the thickness of the first oxidized region is measured.

### [Second Oxidized Region]

The second oxidized region contains an atom of the oxygen barrier layer and a metal of the metal base material. Specifically, the second oxidized region contains an oxide of an atom of the oxygen barrier layer, an oxide of a metal of the metal base material, and/or a composite oxide of an atom of the oxygen barrier layer and a metal of the metal base material. The second oxidized region is relatively closer to the oxygen barrier layer than the first oxidized region.

Similarly to the first oxidized region, the second oxidized region can change in volume when reduced. In this regard, similarly to the first oxidized region, the second oxidized region preferably has a small volume change.

In an embodiment, from the viewpoint of suppressing defects formed in the dielectric layer, the thickness of the second oxidized region may be 10 nm or less, preferably 8 nm or less, more preferably 6 nm or less, still more preferably 4 nm or less, and particularly preferably 2 nm or less.

The thickness of the second oxidized region can be measured by RBS analysis or STEM-EDX analysis. The thickness of the second oxidized region can be measured by a measurement method similar to the measurement method for the thickness of the first oxidized region.

The thickness of the first oxidized region and the thickness of the second oxidized region can be measured, for example, by performing RBS analysis or STEM-EDX analysis on the section of a capacitor prepared by forming a metal-insulator-metal (MIM) on a substrate. When the thickness is measured by RBS analysis, it is preferable to analyze the thickness of the first oxidized region and the thickness of the second oxidized region of a capacitor prepared using a substrate having a substantially smooth surface. The term “substantially smooth” means that the roughness of the substrate surface is, for example, about 1 nm or less. In the STEM-EDX analysis, the thickness of the first oxidized region and the thickness of the second oxidized region of a capacitor prepared using a porous metal base material can be measured in addition to a capacitor prepared using a substrate having a smooth surface.

### [Oxygen Barrier Layer]

In the capacitor of the present disclosure, the oxygen barrier layer 5 is formed on the metal base material 1. The oxygen barrier layer 5 is formed between the oxide layer 4 and the dielectric layer 2. The oxygen barrier layer 5 is difficult to transmit oxygen, and can suppress the movement of oxygen from the dielectric layer 2 to the oxide layer 4 and the movement of oxygen from the oxide layer 4 to the dielectric layer 2.

In an embodiment, the atom of the oxygen barrier layer may include at least one atom of metal and metalloid. The atom of the oxygen barrier layer may include both a metal atom and a metalloid atom, or may include only one of a metal atom and a metalloid atom. The oxygen barrier layer may be a composite made of an alloy, an oxide, a nitride, an oxynitride, or a combination thereof. The atom of the oxygen barrier layer may be an atom of the composite made of an alloy, an oxide, a nitride, an oxynitride, or a combination thereof.

The metal atom of the oxygen barrier layer may be at least one selected from the group consisting of Ti, Al, Cr, Ga, W, Zr, Nb, Ta, Co, Cu, Zn, Sn, Ni, Ag, Fe, Mn, Ir, and Hf. From the viewpoint of more easily suppressing the formation of the oxide layer, the metal atom of the oxygen barrier layer may be Al, Hf, and/or Ti.

The metalloid atom of the oxygen barrier layer may be at least one selected from the group consisting of Si, Ge, As, Sc, B, and Sb. From the viewpoint of more easily suppressing the formation of the oxide layer, the metalloid atom of the oxygen barrier layer may be Si.

In an embodiment, the oxygen barrier layer may be an oxide, a nitride, an oxynitride, or a combination thereof. For example, the oxygen barrier layer may be formed of a material represented by M¹ₐM²_{b}OₓN_{y} (M¹ and M² are each independently Ti, Al, Cr, Ga, W, Zr, Nb, Ta, Co, Cu, Zn, Sn, Ni, Ag, Fe, Mn, Ir, Hf, Si, Ge, As, Sc, B, or Sb, a≥0, b≥0, x≥0, y≥0).

The oxygen barrier layer may contain, for example, one or more selected from the group consisting of silicon oxide (e.g. SiO₂), hafnium oxide (e.g. HfOₓ, such as HfO₂), aluminum oxide (e.g. AlOₓ, such as Al₂O₃, AlO, or a combination thereof), titanium nitride (e.g. TiO₂), and titanium oxynitride (e.g. TiON).

The oxygen barrier layer may be one layer or two or more layers. When two or more oxidation barrier layers are present, each of the layers may be made of the same material or may be made of different materials.

In an embodiment, the oxygen barrier layer and the dielectric layer may be formed of the same material. By adopting such a configuration, the oxygen barrier layer and the dielectric layer can be made of the same material, readily switching materials and easily keeping the quality of the capacitor constant.

In an embodiment, the oxygen barrier layer and the dielectric layer may be formed of materials different from each other. By adopting such a configuration, the oxygen barrier layer can be more difficult to transmit oxygen, and the dielectric layer can be more excellent in withstand voltage characteristics.

In an embodiment, the thickness of the oxygen barrier layer may be 0.1 nm to 20 nm. From the viewpoint of further suppressing oxygen transmission, the thickness of the oxygen barrier layer may be 0.3 nm or more, preferably 0.5 nm or more, and more preferably 1.0 nm or more. The thickness of the oxygen barrier layer may be 15 nm or less, preferably 10 nm or less, more preferably 7 nm or less, more preferably 5 nm or less, and particularly preferably 3 nm or less. When two or more oxygen barrier layers are present, the thickness of the oxygen barrier layer is the total thickness of these two layers.

In an embodiment, the thickness of the oxygen barrier layer may be 20% or less of the thickness of the dielectric layer. From the viewpoint of further addressing a decrease in withstand voltage characteristics, the thickness of the oxygen barrier layer may be 15% or less, and preferably 10% or less of the thickness of the dielectric layer.

The oxygen barrier layer is preferably formed by a gas phase method such as a vacuum deposition method, a chemical vapor deposition (CVD) method, a sputtering method, an atomic layer deposition (ALD) method, and a pulsed laser deposition (PLD) method, or a method using a supercritical fluid. The ALD method is more preferable from the viewpoint that a uniform and dense film can be formed.

### <Capacitor Component>

The present disclosure also provides a capacitor component.

The capacitor component of the present disclosure includes: a first electrode; a dielectric layer formed on the first electrode; an oxide layer formed between the first electrode and the dielectric layer; and an oxygen barrier layer formed between the oxide layer and the dielectric layer, wherein the oxide layer includes: a first oxidized region containing a metal of the first electrode; and a second oxidized region containing an atom of the oxygen barrier layer and a metal of the first electrode, and a thickness of the first oxidized region is 3 nm or less and is 0% to 50% of a thickness of the second oxidized region.

The capacitor component of the present disclosure constitutes the capacitor of the present disclosure. The capacitor component of the present disclosure can be the capacitor of the present disclosure by forming a second electrode with conductivity on the dielectric layer.

The first electrode corresponds to the metal base material of the capacitor of the present disclosure, and can have the same characteristics as the metal base material. For example, the first electrode may be a porous metal base material.

Since the capacitor component of the present disclosure has a feature for addressing a decrease in the withstand voltage characteristics of the capacitor of the present disclosure, the capacitor component of the present disclosure suppresses defects formed in the dielectric layer and the like.

### <Production Method>

Hereinafter, the method for producing the capacitor of the present disclosure will be specifically described.

The method for producing a capacitor of the present disclosure includes: forming an oxygen barrier layer on a metal base material; subjecting the metal base material on which the oxygen barrier layer is formed to reducing treatment; forming a dielectric layer on the oxygen barrier layer; and forming a conductive layer on the dielectric layer.

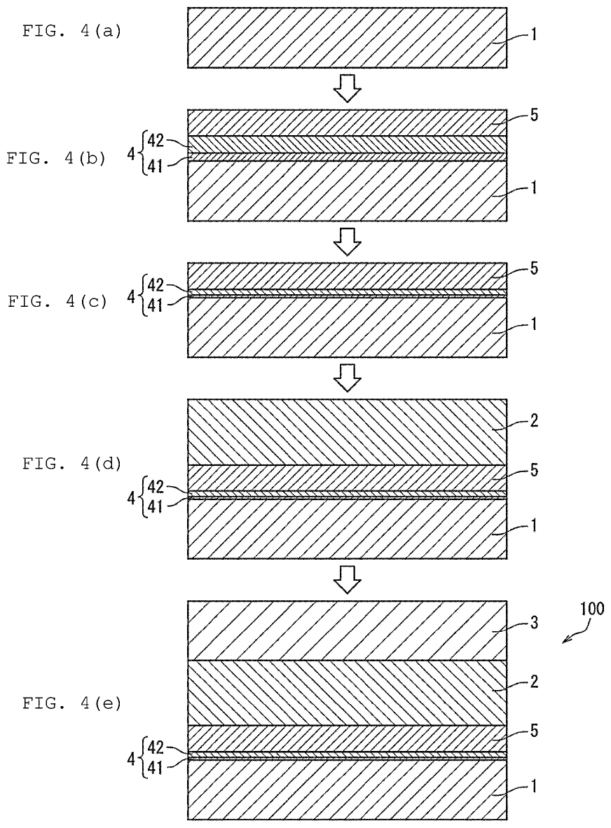

The method for producing a capacitor of the present disclosure will be described in more detail with reference to FIGS.4(a) through 4(e) as an example.

### [Preparation of Metal Base Material]

As shown in FIG. 4(a), a metal base material 1 is prepared. The metal base material 1 may be a metal material usually used as a metal base material of a capacitor. When a porous metal base material is used as the metal base material, the porous metal base material can be prepared by a method well known in the art, such as etching, sintering, or a dealloying method. As the porous metal base material, a commercially available porous metal base material may be used.

### [Formation of Oxygen Barrier Layer]

Next, as shown in FIG. 4(b), an oxygen barrier layer 5 is formed on the metal base material 1. When the oxygen barrier layer is formed, an oxide layer 4 including a first oxidized region 41 and a second oxidized region 42 can be formed on the metal base material 1. When the oxygen barrier layer 5 is formed on the metal base material 1, the oxide layer 4 is difficult to be formed on the metal base material 1 and the thickness of the oxide layer 4 is difficult to increase in the steps after the oxygen barrier layer 5 is formed.

The oxygen barrier layer 5 may be formed using a precursor of a material constituting the oxygen barrier layer 5. For example, as the precursor, trisdimethylaminosilane (also referred to as 3DMAS) or the like can be used to form SiO₂ under an oxidizing agent atmosphere such as O₃. Alternatively, tetrakis (ethylmethylamide) hafnium (TEMAHF), tetrakis (dimethylamide) hafnium (TDMAHF), or the like can be used to form HfO₂ under an oxidizing agent atmosphere such as O₃. From the viewpoint of efficiently forming the oxygen barrier layer 5, the oxygen barrier layer 5 may be formed under a heating condition, for example, under a heating condition of 150° C. to 400° C., and preferably under a heating condition of 200° C. to 300° C.

### [Reduction Treatment]

As shown in FIG. 4(c), after the oxygen barrier layer 5 is formed, reduction treatment is performed. On the metal base material 1, the oxide layer 4 including the first oxidized region 41 and the second oxidized region 42 can be formed during natural oxidation and/or the formation of the oxygen barrier layer. The oxide layer 4 formed on the metal base material 1 can be reduced by the reduction treatment. Through the reduction, the thickness of the oxide layer 4 can become small. Specifically, the thickness of the first oxidized region 41 and the thickness 42 of the second oxidized region, particularly the thickness 41 of the first oxidized region, can become small.

The oxygen barrier layer 5 is formed on the metal base material 1. Therefore, it is suppressed that oxygen reaches the metal base material 1 to form the oxide layer 4 in the steps after the reduction treatment. That is, once the thickness of the oxide layer 4 becomes small in the reduction treatment, the thickness can be kept after the steps after the reduction treatment. Thereby, the thickness is difficult to increase.

The reduction treatment is performed to the metal base material 1 on which the oxygen barrier layer 5 is formed under a reducing atmosphere. The reducing atmosphere may be a condition under which the oxide layer 4 is reduced. For example, the reducing atmosphere may be a condition that the reducing agent and the metal base material 1 on which the oxygen barrier layer 5 is formed are in contact with each other. As the reducing agent, formic acid, H₂, ammonia, CO, or a hydrocarbon gas such as CH₄ may be used. The reducing agent and the metal base material 1 on which the oxygen barrier layer 5 is formed may be brought into contact with each other in air or under air having a low oxygen concentration. From the viewpoint of efficient reduction treatment, the reduction treatment may be performed in vacuum or in an inert gas such as Ar or N₂. For example, the reducing atmosphere may be an N₂—H₂ atmosphere.

The reduction treatment may be performed at room temperature (for example, 5° C. to 35° C.) or at a temperature other than room temperature. From the viewpoint of efficient reduction treatment, the reduction treatment may be performed at a temperature higher than normal temperature. When the reduction treatment is performed at a temperature higher than normal temperature, the reduction treatment is preferably performed in an environment having a low oxygen concentration or an environment containing a reducing agent, from the viewpoint of preventing the metal base material from being oxidized. When the reduction treatment is performed at a temperature higher than normal temperature, the reduction may be performed by heat without using the reducing agent. The temperature higher than normal temperature may be a temperature at which heat treatment is generally performed, or may be a temperature at which the metal base material is annealed. The reduction treatment may be performed, for example, in a vacuum furnace capable of heating under vacuum conditions or in an atmosphere furnace capable of heating under a reducing and/or inert gas.

In an embodiment, the reduction treatment may be performed so that the thickness of the first oxidized region 41 is 3 nm or less. From the viewpoint of further suppressing defects formed in the dielectric layer, the reduction treatment may be performed so that the thickness 41 of the first oxidized region is 2.5 nm or less, and the reduction treatment may be performed so that the thickness is preferably 2 nm or less, more preferably 1.5 nm or less, still more preferably 1.0 nm or less, and particularly preferably 0.5 nm or less.

### [Formation of Dielectric Layer]

As shown in FIG. 4(d), a dielectric layer 2 is formed after the reduction treatment. The dielectric layer 2 may be formed by a method such as an ALD method, a CVD method, plating, bias sputtering, a Sol-Gel method, and electrically conductive polymer filling. In addition, these methods may be used in combination.

The dielectric layer 2 may be formed using a precursor of a material constituting the dielectric layer 2. For example, as the precursor, trimethylaluminium (also referred to as TMA), trisdimethylaminosilane (also referred to as 3DMAS), and the like can be used to form AlSiOₓ under an oxidizing agent atmosphere such as O₃. From the viewpoint of efficiently forming the dielectric layer 2, the dielectric layer 2 may be formed under a heating condition, for example, under a heating condition of 150° C. to 400° C., and preferably under a heating condition of 200° C. to 300° C.

From the viewpoint of forming a dielectric layer having a more excellent insulating property and dielectric constant, the dielectric layer 2 may be formed under an oxidizing atmosphere. As the oxidizing atmosphere, the presence of an oxidizing agent such as ozone or water may be used. When the dielectric layer 2 is formed (particularly formed by an atomic layer deposition method), conventionally, the metal base material 1 is oxidized to form the oxide layer 4 on the metal base material 1. However, in the method for producing a capacitor of the present disclosure, the oxygen barrier layer 5 on the metal base material 1 can suppress formation of the oxide layer 4 on the metal base material 1. Therefore, it is possible to suppress the case where the thickness of the oxide layer 4, which has been thinned in the reduction treatment, is increased by oxidation when the dielectric layer is formed.

### [Formation of Conductive Layer]

As shown in FIG. 4(e), a conductive layer 3 is formed on the dielectric layer 2 after the dielectric layer 2 is formed. The conductive layer 3 can be formed by a method such as an ALD method, a CVD method, plating, bias sputtering, a Sol-Gel method, and electrically conductive polymer filling. In addition, these methods may be used in combination.

From the viewpoint of suppressing the volume change of the oxide layer 4 due to reduction, the conductive layer 3 may be formed by a method such as an ALD method or a CVD method.

From the viewpoint of forming a conductive layer having more excellent conductivity, the conductive layer 3 may be formed under a reducing atmosphere. For example, when a nitride thin film is formed as the conductive layer 3, the nitride conductive layer may be formed by: forming a precursor of the nitride on the dielectric layer 2; and combining the nitride precursor on the dielectric layer 2 with a reducing agent. As the reducing agent, one reducing agent selected from the group consisting of ammonia and hydrogen can be used.

When the conductive layer 3 is formed under a reducing atmosphere, for example, using ammonia or hydrogen as a reducing agent, the reducing agent such as hydrogen can pass through the dielectric layer 2 to reduce the oxide layer 4 on the metal base material 1. In the conventional capacitor, defects may be formed in the dielectric layer 2 and the like after the oxide layer 4 is reduced and the oxide layer 4 shrinks. However, in the capacitor of the present disclosure, the thickness of the oxide layer 4, particularly the first oxidized region, is decreased through the formation of the oxygen barrier layer 5 and the reduction treatment, and thereby the volume change of the oxide layer 4 due to the reduction treatment is small. Therefore, in the method for producing the capacitor 100 of the present disclosure, defects formed in the dielectric layer 2 and the like is suppressed during the production process.

When a porous metal base material is used as the metal base material, the conductive layer is preferably formed by an ALD method. From the viewpoint of forming the conductive layer also in the porous portion of the porous metal base material, the raw material of the conductive layer is preferably a raw material having a high vapor pressure, and may be, for example, tetrakis dimethylamino titanium (TDMAT) or titanium tetrachloride (TiCl₄).

Through the above steps, the capacitor of the present disclosure can be obtained.

While the capacitor and the method for producing the same according to the present disclosure have been described with reference to the capacitor according to the above-mentioned embodiment, the capacitor of the present disclosure is not limited thereto, and various modifications can be made thereto. For example, in any step, the metal base material may be cut to obtain a metal base material having a desired size. For example, a region where the conductive layer and the like are not formed may be formed by: forming a mask on a part of the metal base material; then forming a conductive layer; and finally removing the mask. Through the above steps, the size of the capacitor and the arrangement of various components can be adjusted.

### EXAMPLES

The present disclosure will be described in detail below with reference to Examples, but the present disclosure is not limited to Examples.

### [Evaluation Method]

The characteristics of capacitors produced in the following Examples and Comparative Examples were evaluated using the following equipment.

Probe system: SUMMIT12000 (manufactured by Cascade Microtech)

Semiconductor device parameter analyzer: B1500A (manufactured by Agilent Technologies)

### Example 1

A Si substrate was prepared. On the Si substrate, sputtering was performed to form an adhesion layer made of Ti and having a thickness of 5 nm and a lower electrode made of Ni and having a thickness of 200 nm in this order.

The Si substrate on which the adhesion layer and the lower electrode were formed was placed in the vacuum chamber of an ALD apparatus. Using 3DMAS as a precursor and O₃ as an oxidizing agent, under the condition of 250° C., an oxygen barrier layer made of SiO₂ and having a thickness of about 3 nm was formed on the lower electrode.

The Si substrate on which the oxygen barrier layer was formed was subjected to reduction treatment.

The Si substrate after the reduction treatment was placed again in the vacuum chamber of the ALD apparatus. Using TMA and 3DMAS as a precursor and O₃ as an oxidizing agent, under the condition of 250° C., a dielectric layer made of AlSiOₓ and having a thickness of about 8 nm was formed on the oxygen barrier. (Note that the formula simply expresses the configuration of the dielectric, and does not limit the composition. That is, the “x” attached to “O” may be any value larger than 0, omitting the description of the abundance ratio of each element including metal elements. Hereinafter, the description of the abundance ratio of elements is also omitted for formulas including a similar expression.)

Next, an upper electrode was produced as follows. First, the Si substrate on which the dielectric layer has been formed was placed again in the vacuum chamber of the ALD apparatus. Using TiCl₄ as a precursor and NH₃ as a reducing agent, under the condition of 500° C., a TiN film having a thickness of about 10 nm was formed. In order to form an extended electrode of the upper electrode, a Ti film having a thickness of 5 nm and a Cu film having a thickness of 500 nm were formed on the TiN film. Thereafter, a 1.3 mm square resist pattern was formed by photolithography, and Cu, Ti, and TiN were removed in this order by wet etching. After Cu, Ti, and TiN were removed, the resist pattern was removed. As described above, the upper electrode containing Cu was formed on the dielectric layer.

Through the above steps, obtained was a capacitor including an upper electrode (Cu), a dielectric (AlSiOₓ), an oxygen barrier layer (SiOₓ), and a lower electrode (Ni) (The parentheses show the main component for each). As the characteristics of the capacitor, capacitance, BDV, and leakage current were evaluated. The results are shown in Table 1.

TABLE 1
Evaluation results of capacitance, BDV,
and leakage current in Example 1

| Measurement | Capacitance | | Leakage current |
|---|---|---|---|
| point | (nF) | BDV (V) | (A) *2.5 V |
| 1 | 5.09 | 6.9 | 6.99 × 10⁻¹¹ |
| 2 | 5.03 | 4.8 | 7.05 × 10⁻¹¹ |
| 3 | 5.02 | 5.5 | 7.25 × 10⁻¹¹ |
| 4 | 5.03 | 5.4 | 9.24 × 10⁻¹¹ |
| 5 | 5.06 | 5.1 | 6.79 × 10⁻¹¹ |
| 6 | 5.01 | 5.0 | 6.39 × 10⁻¹¹ |
| 7 | 4.99 | 5.7 | 7.18 × 10⁻¹¹ |
| 8 | 4.98 | 6.4 | 7.11 × 10⁻¹¹ |
| 9 | 5.02 | 6.7 | 7.01 × 10⁻¹¹ |

### Example 2

A capacitor was produced in the same manner as in Example 1 except that AlOₓ was used as the oxygen barrier layer. The oxygen barrier layer using AlOₓ was formed, using TMA (trimethylaluminum) as a precursor and H₂O as an oxidizing agent, under the condition of 250° C. The thickness of the oxygen barrier layer was about 5 nm. As the characteristics of the capacitor, capacitance, BDV, and leakage current were evaluated. The results are shown in Table 2.

TABLE 2
Evaluation results of capacitance, BDV,
and leakage current in Example 2

| Measurement | Capacitance | | Leakage current |
|---|---|---|---|
| point | (nF) | BDV (V) | (A) *2.5 V |
| 1 | 4.77 | 9.4 | 1.12 × 10⁻¹¹ |
| 2 | 4.77 | 7.9 | 1.58 × 10⁻¹¹ |
| 3 | 4.76 | 7.3 | 5.94 × 10⁻¹¹ |
| 4 | 4.77 | 7.8 | 6.31 × 10⁻¹¹ |
| 5 | 4.76 | 8.3 | 9.01 × 10⁻¹¹ |
| 6 | 4.75 | 7.2 | 3.55 × 10⁻¹¹ |
| 7 | 4.82 | 6.2 | 4.31 × 10⁻¹¹ |
| 8 | 4.77 | 7.6 | 2.63 × 10⁻¹¹ |
| 9 | 4.90 | 7.4 | 6.51 × 10⁻¹¹ |

### Example 3

A capacitor was produced in the same manner as in Example 1 except that HfOₓ was used as the oxygen barrier layer. The oxygen barrier layer using HfOₓ was formed, using TEMAHF (tetrakis (ethylmethylamide) hafnium) or TDMAHF (tetrakis (dimethylamide) hafnium) as a precursor and H₂O as an oxidizing agent, under the condition of 250° C. The thickness of the oxygen barrier layer was about 7 nm. As the characteristics of the capacitor, capacitance, BDV, and leakage current were evaluated. The results are shown in Table 3.

TABLE 3
Evaluation results of capacitance, BDV,
and leakage current in Example 3

| Measurement | Capacitance | | Leakage current |
|---|---|---|---|
| point | (nF) | BDV (V) | (A) *2.5 V |
| 1 | 4.29 | 6.5 | 2.87 × 10⁻¹⁰ |
| 2 | 4.13 | 10.6 | 2.73 × 10⁻¹⁰ |
| 3 | 4.32 | 9.2 | 2.96 × 10⁻¹⁰ |
| 4 | 4.06 | 10.0 | 3.30 × 10⁻¹⁰ |
| 5 | 4.21 | 9.5 | 2.60 × 10⁻¹⁰ |
| 6 | 4.15 | 9.5 | 2.96 × 10⁻¹⁰ |
| 7 | 4.33 | 10.2 | 2.67 × 10⁻¹⁰ |
| 8 | 4.14 | 10.7 | 2.87 × 10⁻¹⁰ |
| 9 | 4.24 | 9.9 | 3.37 × 10⁻¹⁰ |

### Example 4

A capacitor was produced in the same manner as in Example 1 except that a Ni porous product was used as the lower electrode. The Ni porous product was prepared as follows.

A Ni conductive paste was applied onto a Ni plate by a screen printing method. After the application, the Ni plate was fired at about 500° C. to form a Ni porous product bonded onto the Ni plate. The dimension of the Ni porous product was 0.5 mm×0.5 mm. The thickness of the Ni porous product was about 20 μm.

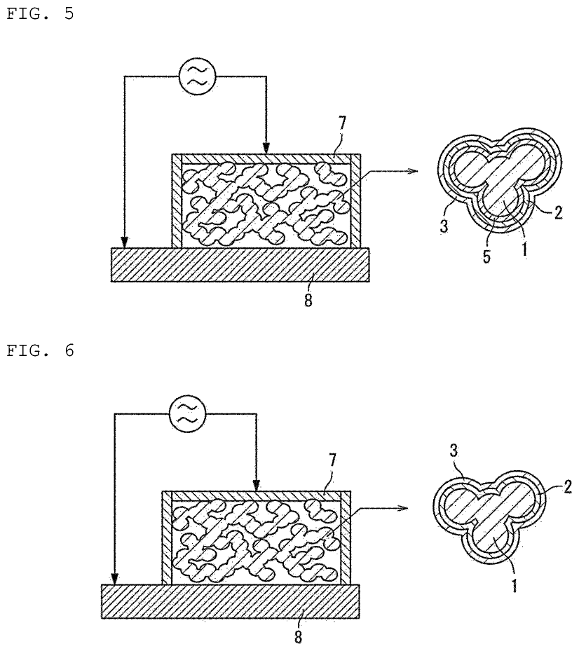

FIG. 5 shows the capacitor using a Ni porous product obtained in Example 4. As shown in FIG. 5, a Ni porous product 1 is provided on a Ni plate 8. A dielectric layer 2, an oxygen barrier layer 5, and a conductive layer 3 as an upper electrode cover the Ni porous product as a metal base material 1 in this order. An extended electrode 7 made of Cu/Ti covers the periphery of the Ni porous product. As the characteristics of the capacitor, capacitance, BDV, and leakage current were evaluated. The results are shown in Table 4.

TABLE 4
Evaluation results of capacitance, BDV,
and leakage current in Example 4

| Measurement | Capacitance | | Leakage current |
|---|---|---|---|
| point | (nF) | BDV (V) | (A) *2.5 V |
| 1 | 390 | 4.7 | 3.78 × 10⁻⁹ |
| 2 | 381 | 4.5 | 3.99 × 10⁻⁹ |
| 3 | 389 | 3.9 | 4.28 × 10⁻⁹ |
| 4 | 392 | 4.6 | 4.09 × 10⁻⁹ |
| 5 | 384 | 4.7 | 4.52 × 10⁻⁹ |
| 6 | 393 | 5.5 | 4.08 × 10⁻⁹ |
| 7 | 380 | 5.8 | 3.43 × 10⁻⁹ |
| 8 | 392 | 4.1 | 3.57 × 10⁻⁹ |
| 9 | 391 | 3.8 | 3.46 × 10⁻⁹ |

### Comparative Example 1

In Comparative Example 1, a capacitor was produced in the same manner as in Example 1 except that the dielectric layer was formed on the lower electrode without forming an oxygen barrier layer on the lower electrode. As the characteristics of the capacitor, capacitance, BDV, and leakage current were evaluated. The results are shown in Table 5.

TABLE 5
Evaluation results of capacitance, BDV, and
leakage current in Comparative Example 1

| Measurement | Capacitance | | |
|---|---|---|---|
| point | (nF) | BDV (V) | Leakage current (A) *2.5 V |
| 1 | 5.89 | 1.4 | Could not be measured |
| 2 | 5.79 | 3.1 | 3.48 × 10⁻³ |
| 3 | 5.81 | 3 | 5.66 × 10⁻⁵ |
| 4 | 5.68 | 0.9 | Could not be measured |
| 5 | 5.86 | 3.5 | 8.18 × 10⁻⁶ |
| 6 | 5.80 | 1.4 | Could not be measured |
| 7 | 5.70 | 1 | Could not be measured |
| 8 | 5.91 | 2 | Could not be measured |
| 9 | 5.85 | 2 | Could not be measured |

### Comparative Example 2

In Comparative Example 2, a capacitor was produced in the same manner as in Example 1 except that the oxygen barrier layer was formed on the lower electrode, and then the dielectric layer was formed on the oxygen barrier layer without performing reduction treatment. As the characteristics of the capacitor, capacitance, BDV, and leakage current were evaluated. The results are shown in Table 6.

TABLE 6
Evaluation results of capacitance, BDV, and
leakage current in Comparative Example 2

| Measurement | Capacitance | | |
|---|---|---|---|
| point | (nF) | BDV (V) | Leakage current (A) *2.5 V |
| 1 | 4.85 | 3.7 | 1.22 × 10⁻⁵ |
| 2 | 4.81 | 1.6 | Could not be measured |
| 3 | 4.82 | 2.4 | Could not be measured |
| 4 | 4.83 | 3.1 | 2.15 × 10⁻⁶ |
| 5 | 4.89 | 1.4 | Could not be measured |
| 6 | 4.93 | 3 | 1.5 × 10⁻³ |
| 7 | 4.94 | 3.9 | 6.64 × 10⁻⁷ |
| 8 | 5.00 | 3.5 | 4.56 × 10⁻⁹ |
| 9 | 4.99 | 4.1 | 1.20 × 10⁻⁵ |

### Comparative Example 3

In Comparative Example 3, a capacitor was produced in the same manner as in Example 4 except that the dielectric layer was formed on the lower electrode without forming an oxygen barrier layer on the lower electrode. FIG. 6 shows the capacitor using a Ni porous product obtained in Comparative Example 3. As shown in FIG. 6, a Ni porous product 1 is provided on a Ni plate 8. A dielectric layer 2 and a conductive layer 3 as an upper electrode cover the Ni porous product as a metal base material 1 in this order. An extended electrode 7 made of Cu/Ti covers the periphery of the Ni porous product. As the characteristics of the capacitor, capacitance, BDV, and leakage current were evaluated.

As a result of the evaluation, the capacitor of Comparative Example 3 has an extremely high leakage current, and could not be measured for capacitance, BDV, and leakage current. Therefore, the capacitor was evaluated that there was a problem in practical use.

### [RBS Analysis]

As samples for RBS analysis, three samples were prepared by the following preparation methods.

### Sample 1

A Si substrate was prepared. On the Si substrate, sputtering was performed to form a layer made of Ti and having a thickness of 5 nm (that is, corresponding to an adhesion layer) and a layer made of Ni and having a thickness of 200 nm (that is, corresponding to a lower electrode) in this order. The Si substrate having the layers formed thereon was defined as Sample 1.

### Sample 2

Sample 1 was placed in the vacuum chamber of an ALD apparatus. Using 3DMAS as a precursor and O₃ as an oxidizing agent, under the condition of 250° C., an oxygen barrier layer made of SiO₂ and having a thickness of about 3 nm was formed on the layer made of Ni of Sample 1. The substrate having the oxygen barrier layer formed thereon was defined as Sample 2.

### [Sample 3]

Sample 2 was subjected to reduction treatment. The substrate obtained after the reduction treatment was defined as Sample 3.

### (Measurement Conditions)

Incident ion: 450 keV He⁺
Detection ion: Scattering He⁺
Scattering angle: 70°
Incident angle*: 55°
Sample current: 10 nA
Irradiation dose: 12.5 μC
In-plane rotation: No
Detector**: MCP/PSD
*Angle of sample surface from normal line
**MCP=Micro Channel Plate, PSD=Position Sensitive Detector, SSD=Solid State Detector

### [RBS Analysis Result]

The results of the RBS analysis for Samples 1 to 3 are shown in Table 7.

TABLE 7
Summary of RBS analysis results for Samples 1 to 3

| | RBS analysis results | | | | |
|---|---|---|---|---|---|
| | First | Second | | Oxygen | (First oxidized |
| | oxidized | oxidized | | barrier | region/Second oxidized |
| | region | region | | layer | region) ×100 |
| Sample 1 | 1.1 nm | | | | |
| Sample 2 | 6.1 nm | 3 | nm | 3.7 nm | 203% |
| Sample 3 | 0.8 nm | 1.8 | nm | 3.2 nm | 44.4% |

### [Sample 1]

A region having a composition of only Ni atoms was observed. The region is considered to be a lower electrode.

A region made of Ni atoms and O atoms was observed. The region is considered to be a layer formed after Ni in the lower electrode is oxidized, corresponding to the first oxidized region according to the present disclosure. The thickness was 1.1 nm.

### [Sample 2]

A region having a composition of only Ni atoms was observed. The region is considered to be a lower electrode.

A region made of Si atoms and O atoms was observed. The region was considered to be a SiO₂ layer constituting the oxygen barrier layer, and the thickness was 3.7 nm.

A region made of Ni atoms and O atoms was observed. The region is considered to be a layer formed after Ni in the lower electrode is oxidized, corresponding to the first oxidized region according to the present disclosure. The thickness was 6.1 nm.

A region made of Si atoms, Ni atoms, and O atoms was observed. The region is considered to be a layer derived from Ni atoms and O atoms in the first oxidized region and SiO₂ in the oxygen barrier layer, corresponding to the second oxidized region according to the present disclosure. The thickness was 3 nm.

In Sample 2, the thickness of the first oxidized region is 203% of the thickness of the second oxidized region.

### [Sample 3]

A region having a composition of only Ni atoms was observed. The region is considered to be a lower electrode.

A region made of Si atoms and O atoms was observed. The region was considered to be a SiO₂ layer constituting the oxygen barrier layer, and the thickness was 3.2 nm.

A region made of Ni atoms and O atoms was observed. The region is considered to be a layer formed after Ni in the lower electrode is oxidized, corresponding to the first oxidized region according to the present disclosure. The thickness was 0.8 nm.

A region made of Si atoms, Ni atoms, and O atoms was observed. The region is considered to be a layer derived from Ni atoms and O atoms in the first oxidized region and SiO₂ in the oxygen barrier layer, corresponding to the second oxidized region according to the present disclosure. The thickness was 1.8 nm.

In Sample 3, the thickness of the first oxidized region is 44.4% of the thickness of the second oxidized region.

Comparing Sample 2 and Sample 3, the thickness of the first region with respect to the thickness of the second oxidized region was smaller in Sample 3 than in Sample 2. This is presumably because reduction treatment was performed after the oxygen barrier layer was formed, and as a result, NiOₓ constituting the first oxidized region was reduced.

Although the embodiments of the capacitor of the present disclosure have been described above, typical examples have been only illustrated. Accordingly, the capacitor of the present disclosure is not limited thereto, and those skilled in the art will readily understand that various aspects are conceivable.

The embodiments of the capacitor of the present disclosure are as follows.

<1> A capacitor including: a metal base material; a dielectric layer on the metal base material; a conductive layer on the dielectric layer; an oxide layer between the metal base material and the dielectric layer; and an oxygen barrier layer between the oxide layer and the dielectric layer, wherein the oxide layer includes: a first oxidized region containing a metal of the metal base material; and a second oxidized region containing an atom of the oxygen barrier layer and a metal of the metal base material, and a thickness of the first oxidized region is 3 nm or less and is 0% to 50% of a thickness of the second oxidized region.

<2> The capacitor according to <1>, wherein the atom of the oxygen barrier layer includes at least one atom of metal and metalloid.

<3> The capacitor according to <1> or <2>, wherein the atom of the oxygen barrier layer includes at least one selected from Si, Hf, Al, and Ti.

<4> The capacitor according to any one of <1> to <3>, wherein the oxygen barrier layer is an oxide, a nitride, an oxynitride, or a combination thereof.

<5> The capacitor according to any one of <1> to <4>, wherein a material of the oxygen barrier layer is the same as a material of the dielectric layer.

<6> The capacitor according to any one of <1> to <4>, wherein a material of the dielectric layer is different from a material of the oxygen barrier layer.

<7> The capacitor according to any one of <1> to <6>, wherein a thickness of the oxygen barrier layer is 20% or less of a thickness of the dielectric layer.

<8> The capacitor according to any one of <1> to <7>, wherein a thickness of the oxide layer is 10% or less of a thickness of the dielectric layer.

<9> The capacitor according to any one of <1> to <8>, wherein a thickness of the oxide layer is 10 nm or less.

<10> The capacitor according to any one of <1> to <9>, wherein the metal base material is a porous metal base material.

<11> The capacitor according to any one of <1> to <10>, wherein the metal of the metal base material includes a non-precious metal.

<12> The capacitor according to any one of <1> to <11>, wherein the metal of the metal base material includes at least one element selected from Cu, Al, Ta, Ti, Ni, Nb, W, Cr, and Fe.

<13> The capacitor according to any one of <1> to <12>, wherein the dielectric layer contains at least one element selected from Al, Si, Ti, Hf, Ta, Zr, Sr, Pb, and Ba.

<14> The capacitor according to any one of <1> to <13>, wherein the conductive layer contains at least one element selected from Ti, W, Ni, Cu, Ag, Ru, and Pt.

<15> The capacitor according to any one of <1> to <14>, wherein the conductive layer comprises a nitride film.

<16> The capacitor according to any one of <1> to <15>, wherein the metal base material is nickel, and the oxygen barrier layer contains at least one selected from silicon oxide, aluminum oxide, and hafnium oxide.

<17> A method for producing a capacitor, the method including: forming an oxygen barrier layer on a metal base material; subjecting the metal base material on which the oxygen barrier layer is formed to a reducing treatment; forming a dielectric layer on the oxygen barrier layer; and forming a conductive layer on the dielectric layer.

<18> The method for producing a capacitor according to <17>, wherein the conductive layer is formed in a presence of at least one reducing agent selected from ammonia and hydrogen.

<19> A capacitor component including: a first electrode; a dielectric layer on the first electrode; an oxide layer between the first electrode and the dielectric layer; and an oxygen barrier layer between the oxide layer and the dielectric layer, wherein the oxide layer includes: a first oxidized region containing a metal of the first electrode; and a second oxidized region containing an atom of the oxygen barrier layer and a metal of the first electrode, and a thickness of the first oxidized region is 3 nm or less and is 0% to 50% of a thickness of the second oxidized region.

<20> The capacitor component according to <19>, wherein the first electrode comprises a porous metal base material.

The capacitor of the present disclosure is remarkably stable and highly reliable, and thus is suitably used in various electronic devices.

### DESCRIPTION OF REFERENCE SYMBOLS

100, 100′: Capacitor
1, 1′: Metal base material
2, 2′: Dielectric layer
3, 3′: Conductive layer
4, 4′: Oxide layer
41: First oxidized region
42: Second oxidized region
5: Oxygen barrier layer
6′: Crack
7: Extended electrode
8: Ni plate

1. A capacitor comprising:
a metal base material;
a dielectric layer on the metal base material;
a conductive layer on the dielectric layer;
an oxide layer between the metal base material and the dielectric layer; and
an oxygen barrier layer between the oxide layer and the dielectric layer,
wherein the oxide layer includes:
a first oxidized region containing a metal of the metal base material; and
a second oxidized region containing an atom of the oxygen barrier layer and a metal of the metal base material, and
a thickness of the first oxidized region is 3 nm or less and is 0% to 50% of a thickness of the second oxidized region.

2. The capacitor according to claim 1, wherein the atom of the oxygen barrier layer includes at least one atom of metal and metalloid.

3. The capacitor according to claim 1, wherein the atom of the oxygen barrier layer includes at least one selected from Si, Hf, Al, and Ti.

4. The capacitor according to claim 1, wherein the oxygen barrier layer is an oxide, a nitride, an oxynitride, or a combination thereof.

5. The capacitor according to claim 1, wherein a material of the oxygen barrier layer is the same as a material of the dielectric layer.

6. The capacitor according to claim 1, wherein a material of the dielectric layer different from a material of the oxygen barrier layer.

7. The capacitor according to claim 1, wherein a thickness of the oxygen barrier layer is 20% or less of a thickness of the dielectric layer.

8. The capacitor according to claim 1, wherein a thickness of the oxide layer is 10% or less of a thickness of the dielectric layer.

9. The capacitor according to claim 1, wherein a thickness of the oxide layer is 10 nm or less.

10. The capacitor according to claim 1, wherein the metal base material is a porous metal base material.

11. The capacitor according to claim 1, wherein the metal of the metal base material includes a non-precious metal.

12. The capacitor according to claim 1, wherein the metal of the metal base material includes at least one element selected from Cu, Al, Ta, Ti, Ni, Nb, W, Cr, and Fe.

13. The capacitor according to claim 1, wherein the dielectric layer contains at least one element selected from Al, Si, Ti, Hf, Ta, Zr, Sr, Pb, and Ba.

14. The capacitor according to claim 1, wherein the conductive layer contains at least one element selected from Ti, W, Ni, Cu, Ag, Ru, and Pt.

15. The capacitor according to claim 1, wherein the conductive layer comprises a nitride film.

16. The capacitor according to claim 1, wherein
the metal base material is nickel, and
the oxygen barrier layer contains at least one selected from silicon oxide, aluminum oxide, and hafnium oxide.

17. A method for producing a capacitor, the method comprising:
forming an oxygen barrier layer on a metal base material;
subjecting the metal base material on which the oxygen barrier layer is formed to a reducing treatment;
forming a dielectric layer on the oxygen barrier layer; and
forming a conductive layer on the dielectric layer.

18. The method for producing a capacitor according to claim 17, wherein the conductive layer is formed in a presence of at least one reducing agent selected from ammonia and hydrogen.

19. A capacitor component comprising:
a first electrode;
a dielectric layer on the first electrode;
an oxide layer between the first electrode and the dielectric layer; and
an oxygen barrier layer between the oxide layer and the dielectric layer,
wherein the oxide layer includes:
a first oxidized region containing a metal of the first electrode; and
a second oxidized region containing an atom of the oxygen barrier layer and a metal of the first electrode, and
a thickness of the first oxidized region is 3 nm or less and is 0% to 50% of a thickness of the second oxidized region.

20. The capacitor component according to claim 19, wherein the first electrode comprises a porous metal base material.
